(19) United States
(12) Patent Application Publication
(10) Pub. No.: US 2026/0086779 A1
(43) Pub. Date: Mar. 26, 2026

(54) AUTOMATED GENERATION OF DESIGN RULE CHECKING CODE WITH LARGE LANGUAGE MODELS

(71) Applicant: NVIDIA Corporation, Santa Clara, CA (US)

(72) Inventors: Chen-Chia Chang, Durham, NC (US); Haoxing Ren, Austin, TX (US); Chia-Tung Ho, San Jose, CA (US)

(21) Appl. No.: 19/005,065

(22) Filed: Dec. 30, 2024

Related U.S. Application Data
(60) Provisional application No. 63/697,882, filed on Sep. 23, 2024.

(51) Int. Cl. G06F 8/35

(52) U.S. Cl. CPC G06F 8/35

(57) ABSTRACT

Embodiments of the present disclosure provide a system for automatically generating design rule checking (DRC) code for a design rule. The DRC code is generated using a first large-language model (LLM) agent and a second LLM agent. The first LLM agent generates a plurality of design rule conditions based on a multi-modal description of the design rule. The second LLM agent generates executable DRC code based on the plurality of design rule conditions. The executable DRC code is executed on example layouts to generate corresponding outputs. The executable DRC code is evaluated by comparing the outputs with corresponding reference outputs. The executable DRC code is iteratively regenerated based on the evaluation, where the evaluation includes providing a performance report to the first LLM agent and/or to the second LLM agent.

### CLAIM OF PRIORITY

This application claims the benefit of U.S. Provisional Application No. 63/697,882, titled “Large Language Model (LLM)-based Automated Design Rule Checking Code Generation” and filed Sep. 23, 2024, the entire contents of which are incorporated herein by reference.

### BACKGROUND

As semiconductor device geometries have continued to shrink, integrated circuit (IC) design and fabrication have become increasingly complex. Design Rule Checking (DRC), a process via which the design of an IC is assessed for compliance with semiconductor fabrication constraints, has become a critical step. In advanced technology nodes (i.e. the latest generations of semiconductor manufacturing technology), design rules have increased in both number and complexity. As a result, place and route (P&R) tools used in physical circuit design often require an integrated DRC checker to ensure manufacturability and to facilitate optimization (e.g. by enabling faster power-performance-area (PPA) optimization loops). However, implementing an integrated DRC checker within a P&R tool typically takes experienced engineers several weeks and numerous iterations of debugging. Furthermore, as technology nodes continue to evolve, engineers must manually redesign DRC checkers for each new technology node, requiring substantial outlays in both time and money and delaying the manufacture and deployment of next-generation ICs.

### SUMMARY

Embodiments of the present disclosure provide a method for automated generation of executable design rule checker (DRC) code. A first large-language model (LLM) agent receives an input prompting generation of executable DRC code for a design rule. The first LLM agent generates a first text prompt requesting an explanation for the design rule as described in a foundry document based on the input. A vision language model (VLM) module generates textual output providing an explanation of the design rule described in the foundry document based on the first text prompt and one or more visual representations of the design rule. The first LLM agent generates a plurality of design rule conditions based on the textual output generated by the VLM module. A second LLM agent generates the executable DRC code based on the plurality of design rule conditions.

### BRIEF DESCRIPTION OF THE DRAWINGS

The present systems and methods for automatically generating DRC code using one or more large language models (LLMs) are described in detail below with reference to the attached drawing figures, wherein:

FIG. 1A illustrates a block diagram of an example system 100 for automated generation of DRC code, in accordance with an embodiment;

FIG. 1B illustrates a flowchart of a method for automatically generating DRC code using one or more LLMs, in accordance with an embodiment;

FIG. 2A illustrates a flowchart of a method for automatically generating DRC code using one or more LLMs, in accordance with an embodiment;

FIG. 2B illustrates a flowchart for converting commercial DRC tool reports to grid-based design rule violations (DRVs), in accordance with an embodiment;

FIGS. 3A-3B illustrate a flowchart of a method for automatically generating DRC code using one or more LLMs, in accordance with an embodiment;

FIG. 3C depicts example communications between a planner and a foundry rule analysis module, in accordance with an embodiment;

FIG. 3D depicts example communications between the planner and a layout DRV analysis module, in accordance with an embodiment;

FIG. 4 is a conceptual diagram of a processing system implemented using a PPU, suitable for use in implementing some embodiments of the present disclosure;

FIG. 5A illustrates an exemplary system in which the various architecture and/or functionality of the various previous embodiments may be implemented;

FIG. 5B illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

The present disclosure provides systems and methods for automating engineering tasks in the semiconductor industry. The systems and methods process multimodal inputs, e.g. in the form of text- and image-based content, using one or more LLM-based agents to synthesize design rules and generate processor-executable code that, when executed by processing circuitry, causes the processing circuitry to carry out an engineering task. In at least one embodiment, the engineering task is DRC code generation. In another embodiment, the engineering task is routing failure hot spot analysis in a physical design routing phase. In yet another embodiment, the engineering task is detecting geometries for optical proximity correction (OPC) in computational lithography.

According to an aspect of the present disclosure, systems and methods are provided for automated generation of design rule checking (DRC) code, thereby improving the overall efficiency of the DRC process-particularly for new technology nodes. DRC code must accurately capture design rule conditions based on explicit design rule descriptions that combine text with visual illustrations to describe complex spatial relationships. In addition, DRC code must account for implicit design rule conditions that may not be explicitly described in documentation provided by foundries. By automating generation of DRC code, the systems and methods of the present disclosure reduce the engineering outlay required to implement DRC in new technology nodes, thereby decreasing both (i) the time required for designing new ICs built on new technology nodes and (ii) the total cost required for production of ICs. Furthermore, by providing novel dataflows that exploit advantages of both LLMs and VLMs to process different representations of design rules for semiconductor fabrication, the systems and methods of the present disclosure automatically generate high-quality DRC code that accounts for both explicit design rule descriptions and implicit design rule conditions. In at least this manner, the systems and methods of the present disclosure provide improvements in integrated circuit design and in place and route (P&R) tools used for physical circuit design.

Design rule information associated with a technology node is generally provided in a foundry document associated with the technology node. The information included in the foundry document is generally present in at least visual and text formats. The foundry documents are also written in a highly complex manner, using numerous abbreviations and a structure that is difficult to interpret without specialized knowledge or experience. Furthermore, violations of design rules are generally depicted using at least portions of circuit layouts. In order to generate effective DRC code that is able to check for design rule violations, all the multi-modal design rule information present in the foundry document and the circuit layouts is to be combined and understood. Embodiments of the present disclosure describe automating the process of generating DRC code by using a combination of LLM- and VLM-based agents and modules to assimilate design rule information and generate corresponding executable DRC code. For example, in at least one embodiment, a first LLM-based agent, with the assistance of a VLM-based module, breaks down multi-modal design rule information provided in a foundry document as both textual and visual representations to generate a first set of design rule conditions. The first LLM-based agent also utilizes a second VLM-based module to interpret design rule violations present in circuit layouts and generate a second set of design rule conditions. The first set of design rule conditions and the second set of design rule conditions are combined by the first LLM-based agent and provided to a second LLM-based agent. The second LLM-based agent uses the combination of the first set of design rule conditions and the second set of design rule conditions to generate executable DRC code. In at least one embodiment, the executable DRC code is subsequently modified by the first LLM-based agent and/or the second LLM-based agent based on a performance evaluation. In at least one embodiment, such modifications are iteratively carried out until the performance of the executable DRC code satisfies acceptance criteria.

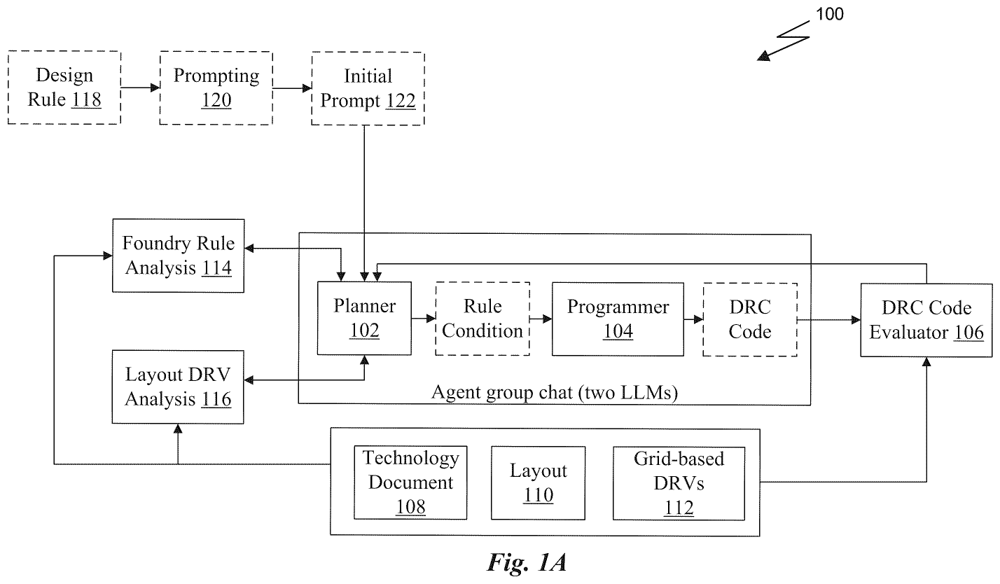

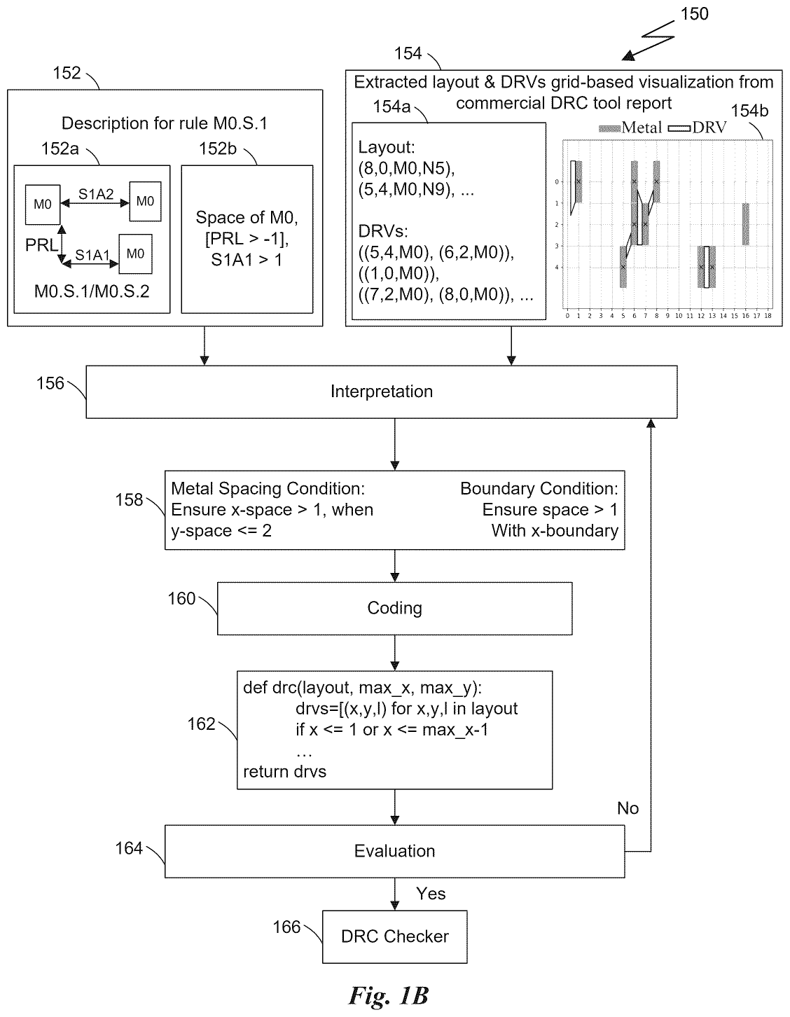

FIG. 1A illustrates a block diagram of an example system 100 for automated generation of DRC code, according to at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of automatically generating DRC code, as performed by system 100, is within the scope and spirit of embodiments of the present disclosure.

System 100 generates design rule checker (DRC) code for each rule of the plurality of design rules of a particular technology node (i.e. a particular generation of semiconductor manufacturing technology). In at least one embodiment, the system 100 generates DRC code for the particular technology node on an individual rule-by-rule basis.

System 100 includes two large language model (LLM)-based agents (i.e. planner 102 and programmer 104), a plurality of data sources (technology documents repository 108, layouts repository 110, and grid-based design rule violations (DRV) repository 112), and a plurality of processing modules (i.e. the foundry rule analysis 114 and the layout DRV analysis 116).

Planner 102 is an LLM-based agent that interprets design rules and generates design rule conditions. In at least one embodiment, planner 102 generates design rule conditions in a grid domain on a rule-by-rule basis. The grid domain divides a layout using a grid-based system to facilitate organization of electronic components and routing paths (e.g., wires) in a systematic way. Features such as pin density, pin proximity, routing metal length, parasitic resistance, parasitic capacitance, and net density can easily be extracted from the grid domain. Planner 102 receives a structured initial prompt 122 as an input. In at least one embodiment, structured initial prompt 122 includes both natural language and image components. The structured initial prompt 122 is generated based on a selected design rule 118 corresponding to the technology node. In at least one embodiment, a prompting process 120 is performed on the selected design rule 118 to generate the structured initial prompt 122. In at least one embodiment, the selected design rule 118 is described multi-modally through a combination of text descriptions and visual illustrations.

Planner 102 processes the structured initial prompt using the layout DRV analysis module 116 and the foundry rule analysis module 114 to output one or more design rule conditions, e.g., in the grid domain. The one or more design rule conditions output by the planner 102 are provided as input to programmer 104.

Planner 102 includes an input interface for receiving the structured initial prompt. In at least one embodiment, the structured initial prompt 122 received by the planner 102 includes a static component and a design rule dependent component. In at least one embodiment, the static component of the structured initial prompt includes: (i) a task definition for developing code to identify, in a circuit layout, a design rule violation (DRV) of a target design rule, (ii) requirements that specify input and output formats for the code, and (iii) a step-by-step guide that divides the coding process into subtasks for planner 102 and programmer 104. In at least one embodiment, the design rule dependent component includes: (i) a description of the target design rule from a foundry document (stored in technology documents repository 108), and (ii) example circuit layouts (stored in layouts repository 110) and corresponding DRV locations (to provide example cases for analysis of the selected design rule).

In at least one embodiment, the example layouts present in the layouts repository 110 include a layout that corresponds to each of multiple design rules of the technology node. In at least one embodiment, the planner 102 selects a layout from the example layouts stored in layouts repository 110 to generate DRC code for the selected design rule. In at least one embodiment, in order to complete the DRC code generation for a selected technology node, the planner 102 iterates through the all the example layouts provided in the layouts repository 110 so that the generation of the DRC code for the technology node is complete.

In at least one embodiment, layouts repository 110 includes example layouts composed of circuit layouts where routing is created without consideration of design rules. In at least one embodiment, the exact DRV locations occurring in the example layouts are generated by executing a commercially available DRC tool over the example layouts to provide DRC reports. In at least one embodiment, the DRC reports for the example layouts, including locations of the DRVs in the example layouts, are stored in grid-based DRV repository 112. In at least one embodiment, the DRC report generated by the commercially available tool is not grid-based. In at least one such embodiment, the generated DRV report is converted to a grid-based DRV report before the DRC report is stored at the grid-based DRV repository 112.

In at least one embodiment, the example layouts present in the layouts repository 110 include a set of layouts that are generated by external tools or human layout engineers to test correctness of DRC code. As described previously, DRV reports associated with the example layouts can be generated by executing a commercially available DRC tool over the example layouts. Such reports are stored in the grid based DRV repository 112. In at least one embodiment where an example layout is generated by a human engineer, the human engineer may provide a grid-based DRV report associated with the example layout. The grid-based DRV report provided by the human layout engineer can also be stored in the grid-based DRV repository 112. In addition to the grid-based DRV reports stored in grid-based DRV repository 112, each example layout in the layouts repository 110 can also be independently labelled with DRV labels that identify occurrence of design rule violations within the example layouts.

In at least one embodiment, example layouts are selected based on random selection or human selection such that the example layouts of the layouts repository 110 include example layouts for each design rule of a technology node. In at least one embodiment, the example layouts are selected based on DRV statistics. In at least one embodiment, example layouts are selected for inclusion in the layouts repository 110 by virtue of having a number DRVs that exceeds a predetermined threshold. In at least one embodiment, example layouts are selected for inclusion in the layouts repository 110 by virtue of having DRVs that correspond to the design rules for which the DRC code is to be generated.

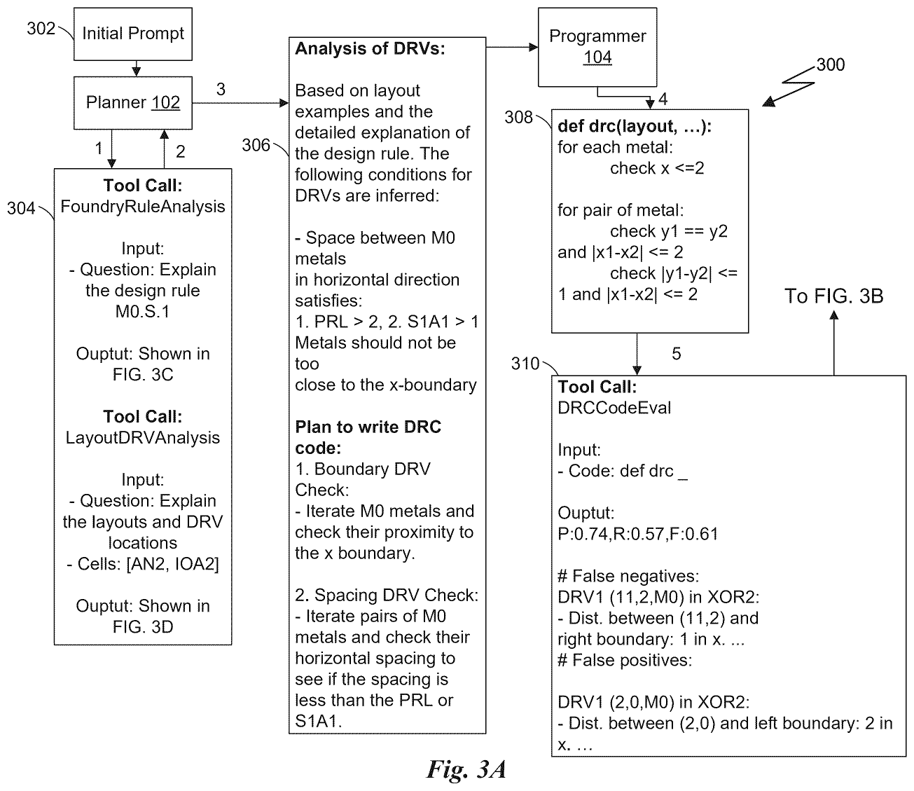

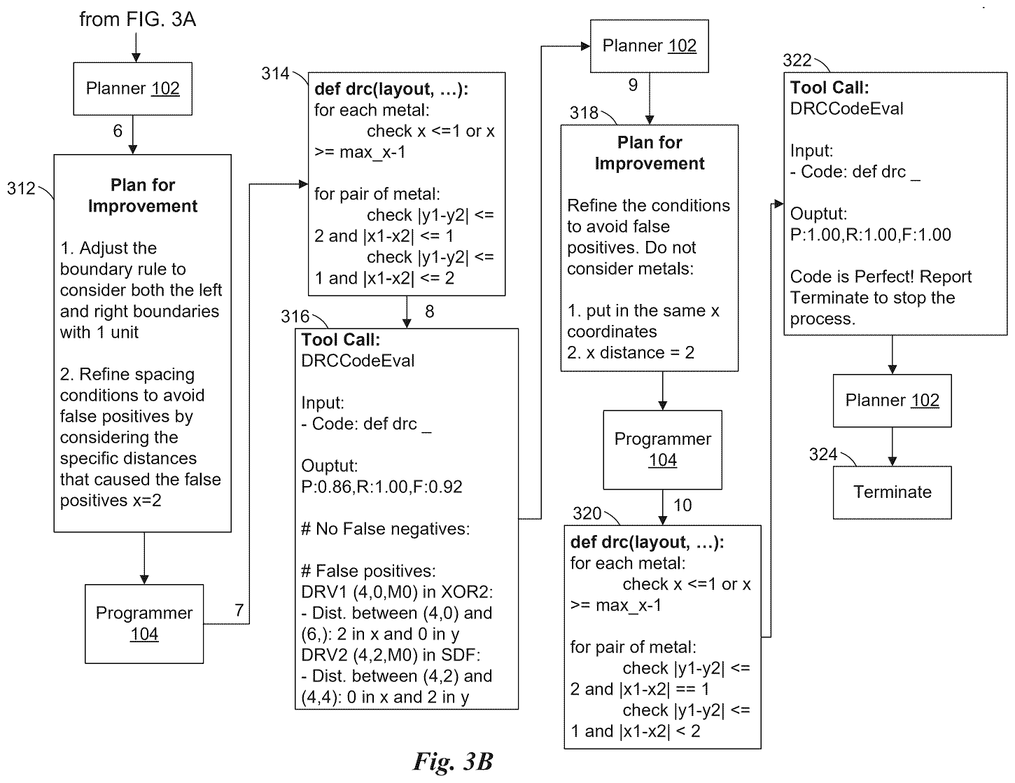

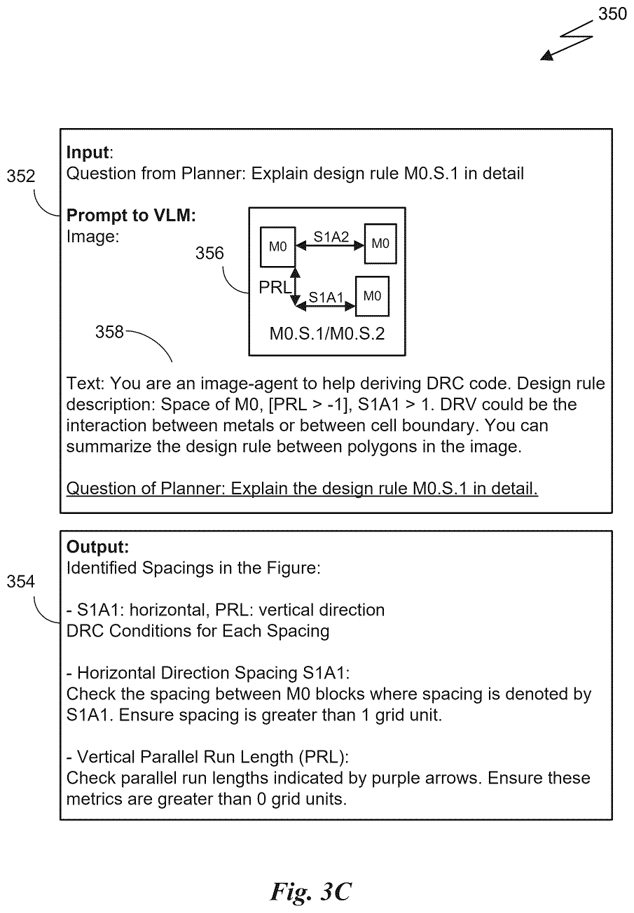

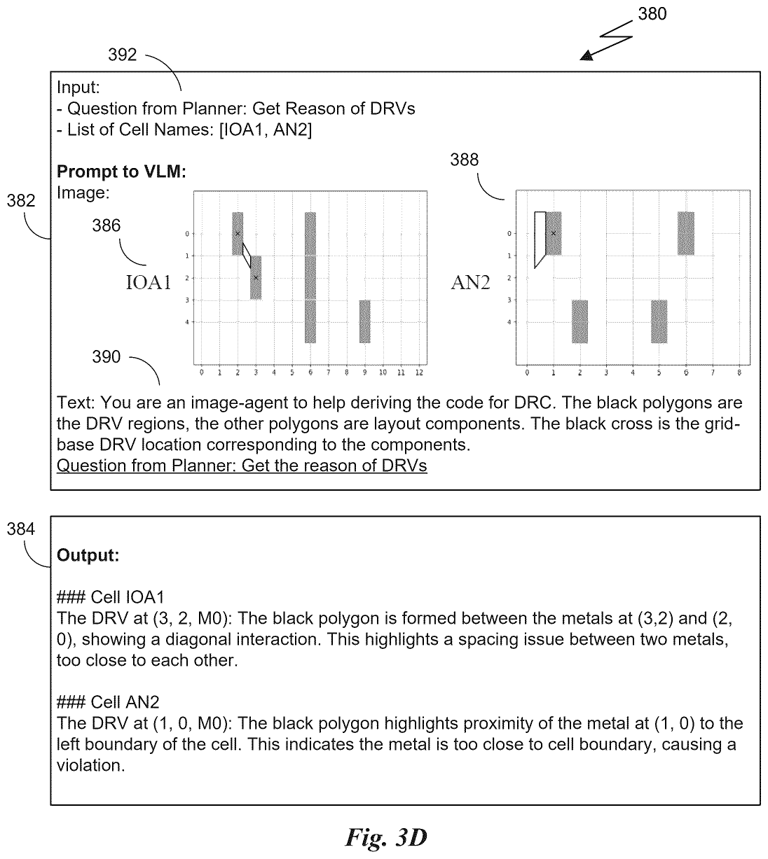

Planner 102 interacts with the layout DRV analysis module 116 to generate accurate grid-based design rule conditions. In at least one embodiment, planner 102 provides a text prompt to the layout DRV analysis module 116 requesting interpretation of a design rule violation (DRV) of the target design rule occurring in one or more select grids of an example layout. In at least one embodiment, the text prompt includes: (1) a question regarding the target design rule and a layout, and (2) one or more specific grid locations within one or more example layouts where a DRV is known to be located. In at least one embodiment, the DRV that is known to be located at the one or more specific grid locations is related to the target design rule. Layout DRV analysis module 116 utilizes a vision language model (VLM) to interpret the specific grid locations and identify key elements, e.g., metal regions and DRV locations within the provided grid locations as identified in the text prompt. In at least one embodiment, layout DRV analysis module 116 generates a comprehensive response that includes an answer to the text prompt and reasons for detected DRVs (including specific coordinates and descriptions of issues like spacing problems or boundary violations). An example of a prompt provided by planner 102 to layout DRV analysis module 116, and of the response provided by layout DRV analysis module 116 are described in more detail with respect to FIG. 3D.

Planner 102 also interacts with the foundry rule analysis module 114 to interpret the selected design rule as recited in the foundry document. Foundry rule analysis module 114 includes a VLM for interpreting the selected design rule as described in the foundry document and generating a design rule condition. In at least one embodiment, planner 102 generates and provides a text prompt to foundry rule analysis module 114 to generate an explanation for the selected design rule in the foundry document, and foundry rule analysis module 114 interprets the information related to the selected rule in the foundry document and provides an answer to the prompt. In at least one embodiment, interpreting information in the foundry document includes interpreting text descriptions and visual illustrations associated with the description of the selected design rule to identify target spacing directions and generate a detailed response for DRC conditions for each spacing requirement associated with the selected design rule. An example of a prompt provided by planner 102 to foundry rule analysis module 114, and of the response provided by foundry rule analysis module 114 are described in more detail with respect to FIG. 3C.

Responses received from foundry rule analysis module 114 and layout DRV analysis module 116 are used by planner 102 to transform design rule information present in foundry documents and example layouts associated with the selected design rule of a technology node into design rule conditions, which are provided to programmer 104. Programmer 104 is an LLM-based agent that receives the design rule conditions from planner 102 and generates executable code based on the received design rule conditions. The executable code is then provided to DRC evaluator 106.

DRC evaluator 106 evaluates the executable code generated by programmer 104 by executing it to detect DRVs in example layouts. In at least one embodiment, a subset of example layouts in layouts repository 110 is associated with the target design rule, and evaluator 106 evaluates the executable DRC code on the example layouts in the subset. In at least one embodiment, evaluator 106 evaluates the executable DRC code by comparing the output of the executable DRC code when executed on one or more selected example layouts with design rule reports associated with the one or more selected example layouts that are generated by a commercially available tool. In at least one embodiment, such design rule reports are stored in grid-based DRVs repository 112. In at least one embodiment, the one or more selected example layouts have labels associated with them that identify whether grids therein are DRC compliant or not DRC compliant. In at least one embodiment, evaluator 106 determines whether the executable code generated by programmer 104 correctly classifies layout grids of the one or more selected example layouts as either DRC-compliant or DRC-violating based on the selected design rule.

In at least one embodiment, evaluator 106 identifies a number of true positives, true negatives, false positives, and false negatives in the output of the executable code generated by programmer 104 by comparing output of the DRC code with grid-based DRVs in the grid-based DRV repository 112 or labels associated with an example layout in layouts repository 110. Truc positives refer correctly identified occurrences of DRVs within a selected example layout by the executable DRC code. True negatives refer to correctly identified non-occurrences of DRVs within a selected example layout by the executable DRC code. False positives refer to incorrectly identified occurrences of DRVs within a selected example layout by the executable DRC code. False negatives refer to incorrectly identified non-occurrences of DRVs within a selected example layout by the executable DRC code.

In at least one embodiment, evaluator 106 utilizes true positives, true negatives, false positives, and false negatives to compute Precision scores, Recall scores, and F1 scores. In at least one embodiment, a Precision score is calculated by dividing a number of true positives occurring in one or more selected example layouts by a number of total positives (true positives and false positives) determined by the executable DRC code in the one or more selected example layouts. In at least one embodiment, a Recall score is calculated by dividing a number of true positives occurring in one or more selected example layouts by a number of true positives and false negatives determined by the executable DRC code in the one or more selected example layouts. In at least one embodiment, an F1 score is calculated as a harmonic mean of a Precision score and a Recall score. The F1 score is particularly suitable for imbalanced datasets, as it focuses on the correct identification of a minority class (e.g., DRC violating) within a dataset (e.g., selected example layouts).

In at least one embodiment, the F1 score is selected as a primary metric for evaluating the executable DRC code generated by programmer 104. The F1 score balances both precision and recall and is, in at least one embodiment, utilized by evaluator 106 to determine whether the executable DRC code correctly replicates the results of a commercial tool when executed on the selected example layouts. In this manner, evaluator 106 determines whether the executable DRC code correctly identifies DRVs occurring in selected example layouts and does not falsely detect DRVs in the selected example layouts. If both measures are completely satisfied, the F1 score associated with the executable DRC code reaches a maximum value of 1.00.

If the results of the evaluation, by evaluator 106, of the executable code generated by programmer 104 demonstrate that the executable code provides results that match those provided by a commercially available DRC tool, the executable DRC code is finalized for use over other layouts of the same technology node. In at least one embodiment, the F1 score calculated for the executable DRC code is compared to a threshold score (e.g., 1.00), to determine whether the performance of the executable DRC code is acceptable. If the calculated F1 score is greater than or equal to the threshold, the executable DRC code is finalized. In at least one embodiment, the threshold F1 score is 1.00 such that the executable DRC code is expected to detect every design rule violation occurring in the selected example layouts.

Additionally, and/or alternatively, if the executable code generated by programmer 104 achieves an F1 score less than the threshold, the results of the do not match those of the commercially available tool. In at least one embodiment, evaluator 106 produces a performance report and provides the performance report to planner 102 if the calculated F1 score is less than the threshold score. In at least one embodiment, the evaluator 106 provides, as a component of the performance report, an identification of selected example layouts for which a mismatch resulted between the output of the executable DRC code and associated DRV labels.

In at least one embodiment, planner 102 revises, based on the performance report provided by evaluator 106, the design rule conditions. In at least one embodiment, programmer 104 conducts debugging, based on the performance report provided by evaluator 106, on the executable DRC code. In at least one embodiment, the processes of revising, by planner 102, and/or debugging, by programmer 104, are performed iteratively until the performance of the executable DRC code generated by programmer 104, as measured by the evaluator 106, satisfies performance criteria (e.g. produces results similar to the commercially available tool). In at least one embodiment, the iterative process of generating the executable DRC code continues until either the calculated F1 score is greater than or equal to the threshold (e.g. 1.00), or a maximum number of iterations for generating the executable DRC code have been performed. In at least one embodiment, the maximum number of iterations for generating the executable DRC code is predefined based on computing capacity, memory capacity, and speed of computation.

FIG. 1B illustrates a flowchart of a method for automatically generating DRC code using one or more LLMs, in accordance with at least one embodiment. Each block of method 150, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 150 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 150 is within the scope and spirit of embodiments of the present disclosure.

Method 150 includes an interpretation phase 156, coding phase 160 and an evaluation phase 164.

The interpretation phase 156 receives, as input, one or more of (1) a description of a design rule 152, and/or (2) extracted layout and grid-based visualization of DRVs from a commercial DRV tool report 154. In at least one embodiment, the description of the design rule 152 is extracted from a foundry document associated with a technology node. As shown in FIG. 1B, the description of the design rule (M.0.S1) is in a multi-modal form. For example, the description of the design rule 152 includes a text portion 152b and an image portion 152a, both of which are extracted from the foundry document. As shown in FIG. 1B, the text portion 152b of the design rule M0.S.1 is provided as “Space of M0, [PRL>−1], SIA1>1,” while the image portion 152a includes an image that provides a pictorial description of the design rule M0.S.1. In at least one embodiment, a single image can depict more than one design rule. For example, the image 152a of the design rule description 152 includes pictorial depictions of design rule M0.S.1 and M0.S.2.

In at least one embodiment, the description of the design rule 152 is provided by planner 102 to foundry rule analysis module 114 as part of a prompt. Foundry rule analysis module 114 receives the description of the design rule 152 and interprets the multi-modal design rule description to generate an answer to the prompt, including interpreting text descriptions and visual illustrations associated with the description of the selected design rule to identify target spacing directions. The answer is provided to the planner 102, which utilizes the answer to generate the design rule conditions 158. For example, foundry rule analysis module 114 may interpret the acronym “PRL” to mean parallel run length (PRL) to determine the actual design rule M0.S.1.

The interpretation phase 156 further receives, as input, multi-modal information captured in an extracted layout and grid-based visualization of DRVs from a commercial DRV tool report 154. In at least one embodiment, the extracted layout and DRVs grid-based visualization is generated by executing a commercial DRC tool over an example layout stored in layouts repository 110. In at least one embodiment, the extracted layout and DRV grid-based visualization are already present in a grid-based DRV repository (e.g. grid-based DRV repository 112). As shown in FIG. 1B, the extracted layout and grid-based visualization of DRVs 154 includes an extracted layout portion 154b and a grid-based DRV listing 154a.

In at least one embodiment, planner 102 provides extracted layout 154b and the grid-based visualizations 154a to layout DRV analysis module 116 requesting an interpretation for a design rule violation (DRV) of the target design rule occurring in one or more select grids, and the layout DRV analysis module 116 interprets the multi-modal input to generate a comprehensive response that includes an answer to a text prompt and reasons for detected DRVs (e.g., including specific coordinates and descriptions of issues like spacing problems or boundary violations).

As shown in FIG. 1B, based on the interpretation of the description of the design rule 152 (i.e., the description of design rule M0.S.1) and the extracted layout and grid-based visualization of DRVs 154, design rule condition 158 is generated. The design rule condition 158 is represented as “Metal Spacing Condition: Ensure x-space>1, when y-space<=2” and “Boundary Condition: Ensure space>1 with x-boundary.”

At coding phase 160, executable DRC code 162 is generated based on the generated design rule conditions 158. In at least one embodiment, programmer 104 generates the executable DRC code 162.

At evaluation phase 164, the performance of the executable DRC code 162 is evaluated. In at least one embodiment, the performance of the executable DRC code 162 is determined by executing the executable DRC code 162 over example layouts that are present in a layouts repository (e.g. layouts repository 110). In at least one embodiment, the evaluation phase 164 compares the output of the executable DRC code 162, when executed on example layouts, with labels assigned to the example layouts. In at least one embodiment, the evaluation phase 164 compares the output of the executable DRC code 162, when executed on example layouts, with respective grid-based DRVs associated with the example layouts stored in a grid-based DRV repository (e.g. grid-based DRV repository 112). In at least one embodiment, the evaluation phase 164 determines whether the executable DRC code 162 is able to correctly classify layout grids of the example layout as either DRC-compliant or DRC-violating based on the selected design rule (i.e., as shown in FIG. 1B, rule M0.S.1). In at least one embodiment, the evaluation phase 164 determines true positives, true negatives, false positives, and false negatives from the output of the executable DRC code 162, and generates Precision, Recall, and F1 scores. In at least one embodiment, the F1 score generated for the executable DRC code is compared to a threshold score (e.g., 1.00), to determine whether the performance of the executable DRC code is acceptable. In at least one embodiment, if the evaluation phase 164 determines that the performance of the executable DRC code 162 is satisfactory (i.e., satisfies an acceptance criteria, e.g., the calculated F1 score is equal to 1.00), the executable DRC code is finalized at 166.

Additionally, and/or alternatively, if the evaluation phase 164 determines that the performance of the executable DRC code 162 is unsatisfactory, the evaluation phase 164 produces a performance report, which is provided to a subsequent iteration of interpretation phase 156. In at least one embodiment, the performance report is generated by comparing the results of executing the executable DRC code 162 on one or more selected example layouts with DRV labels for those same one or more selected example layouts. The subsequent iteration of interpretation phase 156 uses the performance report to perform reasoning and provide revised design rule conditions. In at least one embodiment, a subsequent iteration of the programming phase 160 utilizes the performance report to conduct debugging on the executable DRC code. is the interpretation phase 156, coding phase 160, and evaluation phase 164 are iteratively repeated until the performance of the executable DRC code 162, as measured by the evaluation phase 164 satisfies acceptance criteria.

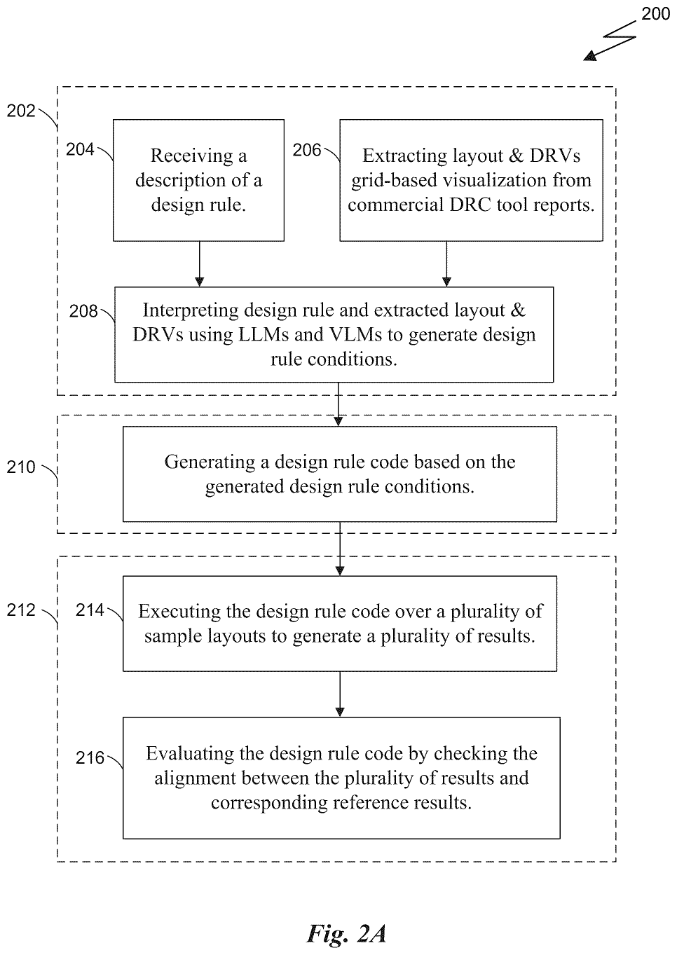

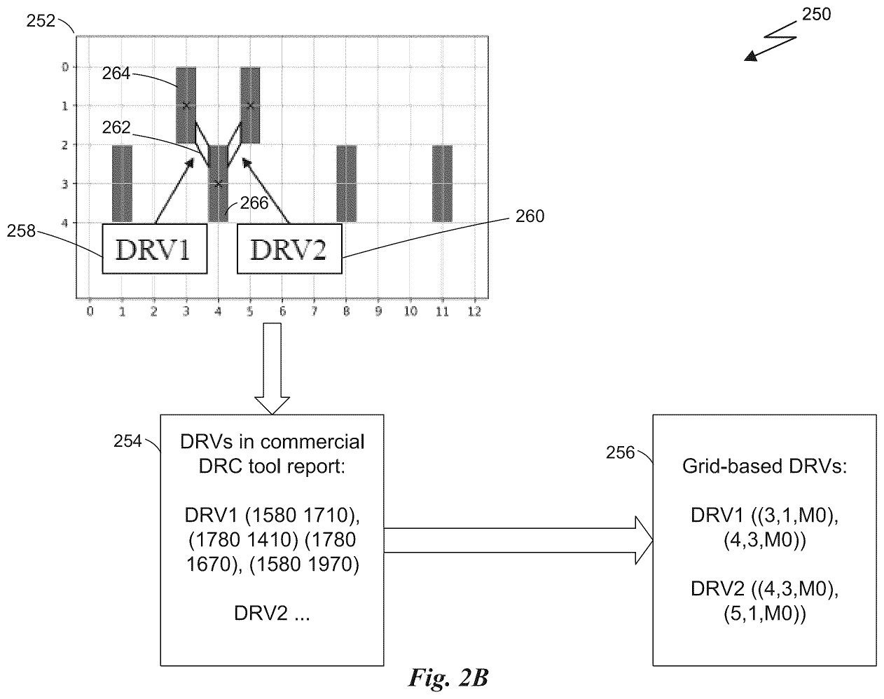

FIG. 2A illustrates a flowchart of a method for automatically generating DRC, in accordance with at least one embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure.

Method 200 includes a planning phase 202, a code generation phase 210, and a code evaluation phase 212. The planning phase 202 receives, at 204, a description (e.g. description 152 as shown in FIG. 1B) of a target design rule of a technology node. In at least one embodiment, the selected design rule is explicitly described as a combination of text and visual illustrations (e.g., as shown in FIG. 1B) and is stored in technology documents repository (e.g. technology documents repository 108 in FIG. 1A). Additionally, at 206, the planning phase 202 extracts layout and DRVs grid-based visualization (e.g. from commercial DRC tool reports 154 as shown in FIG. 1B). In at least one embodiment, a commercially available DRC code is executed over example layouts to generate example design rule reports that include grid-based visualization of design rule violations (DRVs) as reference for understanding complex spatial aspects of the selected design rule.

The planning phase 202 interprets, at 208, the selected design rule and extracted layout and DRVs using LLM- and VLM-based agents/modules to generate design rule conditions. For example, the description of the design rule documents and the extracted layout and DRVs grid-based visualization are used by the LLM- and VLM-based agents/modules to generate design rule conditions associated with the selected design rule in a grid domain. In at least one embodiment, an LLM-based agent queries one or more VLMs to analyze various parts of the text descriptions, visual illustrations, and example layouts related to the target design rule. The responses from the VLMs are used to transform design rule information present in foundry documents and example layouts associated with the target design rule into design rule conditions.

The code generation phase 210, generates design rule code based on the generated design rule conditions. In at least one embodiment, an LLM-based agent receives the design rule conditions and generates executable code based on the received design rule conditions.

Once the DRC code is generated, code evaluation phase 212 executes, at 214, the executable code over a plurality of sample layouts to generate a plurality of results, for example, to detect DRVs in example layouts.

The code evaluation phase 212 evaluates, at 216, the executable code by checking the alignment between the plurality of results and corresponding example design rule reports. In at least one embodiment, outputs of the executable code when executed on the example layouts are compared with design rule reports associated with each layout of the example layouts that are generated by a commercially available tool. In at least one embodiment, an F1 score is calculated as a harmonic mean of precision and recall scores to evaluate performance of the generated executable code.

FIG. 2B illustrates a flowchart for converting commercial DRC tool reports to grid-based design rule violations (DRVs), in accordance with an embodiment. Each block of method 250, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 250 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 250 is within the scope and spirit of embodiments of the present disclosure.

Example layout 252 includes a first DRV 258 and a second DRV 260. In at least one embodiment, example layout 252 is stored in layouts repository 110 of FIG. 1A. In at least one embodiment, a commercial DRC checker can be executed on an example layout stored in layouts repository 110 to determine DRVs 258, 260 occurring in example layout 252. As described with respect to FIG. 1A, the determined DRVs of the example layout are used for evaluating the executable DRC code as it is generated. In at least one embodiment, the determined DRVs 258, 260 are used to label the example layout 252.

In at least one embodiment, the determined DRVs 258, 260 are stored in the grid-based DRV repository 112. In at least one embodiment, to store the DRVs 258, 260 in the grid-based repository 112, they are represented in a grid-based form. In at least one embodiment, the DRVs 258, 260 in the DRC tool report 254 are converted to grid-based DRVs 256. In at least one embodiment, a commercially available DRC tool generates DRC tool report 254, which identifies locations of the first DRV 258 and the second DRV 260 using polygons (e.g., polygon 262 representing the second DRV 260), where the polygon 262 is defined by four points with x and y coordinates. As shown in FIG. 2B, the polygon of the first DRV 258 is represented as a collection of 4 (x, y) coordinates such as (1580 1710), (1780 1410) (1780 1670), (1580 1970). In at least one embodiment, to convert the DRC tool report 254 to a grid-based DRV, the layout components (e.g., polygons 264 and 266) that are intersecting the polygon 262 of the first DRV 258 are identified. The grid coordinates of the polygons 264 and 266 are used to represent the first DRV 258 as a grid-based DRV. For example, the first DRV 258 is represented using grid coordinates of layout components 264 and 266, as shown in 256. As a grid-based DRV, the first DRV 258 is represented as ((3,1,M0), (4,3,M0)). Similarly, the second DRV 260 is represented as ((4,3,M0), (5,1,M0)), as shown in grid-based DRV 256. In at least one embodiment, the determined grid-based DRV 256 is stored in grid-based DRV repository 112 of FIG. 1A. In at least one embodiment, the grid-based DRV 256 is used to assign labels to the example layout 252. In at least one embodiment, the labels of the example layout, or the grid-based DRV stored in the grid-based DRV repository 112, are used to evaluate executable DRC code.

FIGS. 3A-3B illustrate a flowchart of a method for automatically generating DRC code using one or more LLMs, in accordance with an embodiment. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At 302, the method 300 provides an initial prompt to planner 102. In at least one embodiment, the initial prompt includes a static component and a design rule dependent component. In at least one embodiment, the static component of the structured initial prompt includes: (1) a task definition for developing code to identify, in a circuit layout, a design rule violation (DRV) of a target design rule, (2) requirements that specify input and output formats for the code, and (3) a step-by-step guide that divides the coding process into subtasks for planner 102 and programmer 104. In at least one embodiment, the design rule dependent component includes: (1) a description of the target design rule from a foundry document (stored in technology documents repository 108), and (2) example circuit layouts (stored in layouts repository 110) and corresponding DRV locations (to provide example cases for analysis of the selected design rule).

At 304, planner 102 processes the initial prompt using a layout DRV analysis module 116 and foundry rule analysis module 114. At 304, planner 102 processes the initial prompt 302 to provide a first prompt to the foundry rule analysis module 114. Based on the first prompt, foundry rule analysis module 114 provides an output to planner 102. The communication between planner 102 and foundry rule analysis 114 is described in more detail in FIG. 3C.

Additionally, and/or alternatively, planner 102 processes the initial prompt 302 provide a second prompt to layout DRV analysis module 116 requesting an interpretation for a design rule violation (DRV) of the target design rule occurring in a select grid(s) of an example layout. Based on the second prompt, layout DRV analysis module 116 provides an output to planner 102. The communication between planner 102 and layout DRV analysis 116 is described in more detail in FIG. 3D.

Planner 102 combines the output received from the foundry rule analysis module 114 and the layout DRV analysis module 116 to generate a set of design rule conditions at 306. Planner 102 provides the design rule conditions 306 to a programmer 104. The programmer 104 generates executable DRC code 308 based on the design rule conditions provided by planner 102.

At 310, method 300 initiates an evaluation of the generated executable DRC code 308. In at least one embodiment, the evaluation of the executable DRC code 308 is performed by an evaluator 106 using a method as shown in 310. In at least one embodiment, the evaluator 106 executes the executable DRC code 308 on example layouts present in the layouts repository 110. The output of the executable DRC code 308, as executed on the example layouts, is compared with reference data. In at least one embodiment, the reference data cab include labels assigned to the example layouts. In at least one embodiment, the reference data includes grid-based DRV representations in the grid-based DRV repository 112, associated with the example layouts.

Based on comparing the output of the executable DRC code 308 with the reference data, the method DRCCodeEval determines a number of false negatives and false positives determined by the executable DRC code in the example layouts. The false negatives, false positives, in combination with the true negatives and true positives can be used to calculate Precision scores, Recall scores, and F1 scores. As shown in 310, the Precision score calculated for the executable DRC code 308 is 0.74, the Recall score calculated for the executable DRC code 308 is 0.57, and the F1 score calculated for the executable DRC code 308 is 0.61. Because the calculated F1 score is less than a threshold value of 1.00, a performance report is provided to the planner 102. In some embodiments, the performance report is be generated by comparing the results of executing the executable DRC code on the example layout with DRV labels present in the example layout.

Based on the performance report provided, the planner 102 generates a plan 312 for improving the executable DRC code. The plan to improve the executable DRC code includes a modification of the design rule conditions generated at 306 based on the results received from evaluator 106. Planner 102 provides the modified design rule conditions to programmer 104. For example, based on the results received from the evaluator, planner 102 can modify the existing design rule conditions to “Adjust the boundary rule to consider both the left and right boundaries with 1 unit” and “Refine spacing conditions to avoid false positives by considering the specific distances that caused the false positives x=2,” as shown in 312. In at least one embodiment, in addition to the modified design rule conditions, evaluator 106 can provide example layouts to the planner 102. The example layouts that are provided by evaluator 106 to planner 102 are those select layouts where a mismatch is detected between the output of the executable DRC code and labels associated with the select layouts. Then, in the debugging iterations, planner 102 selects the layout that has DRV mismatch between the written code and DRV labels. Based on the modified design rule conditions, programmer 104 generates a modified version of the executable DRC code 314.

At 316, method 300 initiates an evaluation of the modified version of the executable DRC code 314. Similar to 310, the evaluation at 316 of the executable DRC code 314 is performed by evaluator 106 using a method as shown in 316. In at least one embodiment, the evaluator 106 executes the executable DRC code 314 on example layouts present in the layouts repository 110. The output of the executable DRC code 314, as executed on the example layouts, is compared with reference data. In at least one embodiment, the reference data includes labels assigned to the example layouts. In at least one embodiment, the reference data includes grid-based DRV representations in the grid-based DRV repository 112, associated with the example layouts.

Based on comparing the output of the executable DRC code 314 with the reference data, the method DRCCodeEval determines a number of false negatives and false positives determined by the executable DRC code in the example layouts. The false negatives, false positives, in combination with the true negatives and true positives can be used to calculate Precision scores, Recall scores, and F1 scores. As shown in 316, the Precision score calculated for the executable DRC code 314 is 0.86, the Recall score calculated for the executable DRC code 314 is 1.00, and the F1 score calculated for the executable DRC code 314 is 0.92. Because the calculated F1 score is less than a threshold value of 1.00, a second performance report is provided to the planner 102. In at least one embodiment, the performance report is generated by comparing the results of executing the executable DRC code on the example layout with DRV labels present in the example layout.

Based on the performance report provided, the planner 102 generates a plan 318 for improving the executable DRC code 314. The plan to improve the executable DRC code 314 can include an improvement on the modification of the design rule conditions generated at 312 based on the results received from the evaluator 106. The planner 102 provides the improved modified design rule conditions to the programmer 104. For example, based on the results received from the evaluator, planner 102 improves the modifications of the existing design rule conditions to “Refine the conditions to avoid false positives. DO not consider metals: 1. Put in the same x coordinates, and 2. x distance=2,” as shown in 318. Based on the modified design rule conditions, programmer 104 generates an improved and modified version of the executable DRC code 320.

At 322, method 300 initiates an evaluation of the modified version of the executable DRC code 320. Similar to 316, the evaluation at 322 of the executable DRC code 320 is performed by evaluator 106 using a method as shown in 322. In at least one embodiment, evaluator 106 executes the executable DRC code 320 on example layouts present in the layouts repository 110. The output of the executable DRC code 320, as executed on the example layouts, is compared with reference data. In at least one embodiment, the reference data includes labels assigned to the example layouts. In at least one embodiment, the reference data includes grid-based DRV representations in the grid-based DRV repository 112, associated with the example layouts.

Based on comparing the output of the executable DRC code 320 with the reference data, the method DRCCodeEval determines a number of false negatives and false positives determined by the executable DRC code in the example layouts. The false negatives, false positives, in combination with the true negatives and true positives can be used to calculate Precision scores, Recall scores, and F1 scores. As shown in 322, the Precision score calculated for the executable DRC code 320 is 1.00, the Recall score calculated for the executable DRC code 322 is 1.00, and the F1 score calculated for the executable DRC code 320 is 1.00. Because the calculated F1 score is now equal to the threshold value of 1.00, the executable DRC code 320 is considered acceptable. In such embodiments, evaluator 106 provides a message to the planner 102 stating that “Code is perfect! Report Terminate to stop the process.” Upon receiving the information from evaluator 106, planner 102 terminates the method 300 at 324 and providing the executable DRC code 320 as output. In at least one embodiment, if the F1 score associated with the executable DRC code is unable to reach the threshold value of 1.00, the iterative process to generate and modify the executable DRC code can be performed until a maximum number of iterations for generating the executable DRC code have been performed.

FIG. 3C depicts example communications between a planner and a foundry rule analysis module, in accordance with an embodiment. As discussed with respect to FIG. 3A, planner 102 interacts with foundry rule analysis module 114 to better interpret the selected design rule as recited in the foundry document. For example, planner 102 generates and provides a prompt 352 to the foundry rule analysis module 114 to generate an explanation for the selected design rule in the foundry document. In at least one embodiment, the prompt 352 includes a text portion 358 and an image portion 356.

The text portion 358 includes an identification and description of the selected design rule (e.g., design rule M0.S.1). The design rule M0.S.1 can be described as “Space of M0, [PRL>−1], SIA1>1. DRV could be the interaction between metals or between cell boundaries. You can summarize the design rule between polygons in the image,” in the foundry document associated with the technology node. In at least one embodiment, the selected design rule M0.S.1 can be extracted from a foundry document associated with a technology node.

Additionally, the prompt 352 also includes an image portion 356 that is accompanied with the description of the design rule as present in the text portion 358 of the prompt 352. The image portion 356 in the prompt 352 associated with the selected design rule M0.S.1 is also present in the foundry document of the technology node. In addition to the text portion 358 and the image portion 356, the prompt 352 includes a question from planner 102. For example, the question recites “Explain the design rule M0.S.1 in detail.” In at least one embodiment, the image associated with the design rule may include depictions of more than one design rule. For example, the image portion 356 provided in prompt 352 is related to two design rules M0.S.1 and M0.S.2. The foundry rule analysis module 114 filters the information in the image of the prompt 352, based on information provided in the text portion 358 of the prompt 352 to analyze a portion of the image portion 356 of the prompt 352. For example, the foundry rule analysis 114 extracts information related to design rule M0.S.1 from the image portion 356 of the prompt 352.

The foundry rule analysis module 114 uses a VLM to analyze the prompt 352 to prepare a response 354 for the planner 102. For example, the response 354 includes an analysis of the text portion 358 and image portion 356 of the design rule related to horizontal spacing S1A1, and parallel run length (PRL) as described in design rule M0.S.1. The output provided by the foundry analysis module 114 are used by the planner 102 to generate design rule conditions. The design rule conditions are provided to the programmer 104 to generate executable DRC code associated with the selected design rule M0.S.1.

FIG. 3D depicts example communications between a planner and a layout DRV analysis module, in accordance with an embodiment. As discussed previously, planner 102 provides a prompt to layout DRV analysis module 116 requesting an interpretation for a design rule violation (DRV) of a selected design rule occurring in a select grid(s) of an example layout. The prompt includes text portions 390 and 392 and an image portion including portions of example layouts 386 and 388. In at least one embodiment, the text portion 392 includes (1) a question regarding the target design rule and a layout (e.g., “Get Reason for DRVs”), and (2) one or more specific grid locations within one or more example layouts where a DRV is known to be located. In at least one embodiment, the image portion of the prompt 382 includes portions of example layouts 386 and 388 including the specific grid locations where the DRV is located (e.g., [IOA1, AN2]). In at least one embodiment, the text portions 390 and 392 of the prompt 382 includes a request for explanation of DRVs in the portions of layouts 386 and 388 occurring in the image portion of the prompt 382 (e.g., “Get Reason for DRVs”).

The layout DRV analysis module 116 utilizes a VLM to interpret the specific grid locations of the one or more example layouts. The layout DRV analysis module 116 identifies key elements such as metal regions and DRV locations within the provided grid locations as identified in the text prompt. The layout DRV analysis module 116 generates a response 384 that includes an answer to the text prompt and reasons for detected DRVs (including specific coordinates and descriptions of issues like spacing problems or boundary violations). The planner 102 utilizes the response 384 to generate design rule conditions. The design rule conditions are provided to the programmer 104 to generate executable DRC code.

More illustrative information will now be set forth regarding various optional architectures and features with which foregoing embodiments may be implemented, per the desires of the user. It should be strongly noted that the following information is set forth for illustrative purposes and should not be construed as limiting in any manner. Any of the following features may be optionally incorporated with or without the exclusion of other features described.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

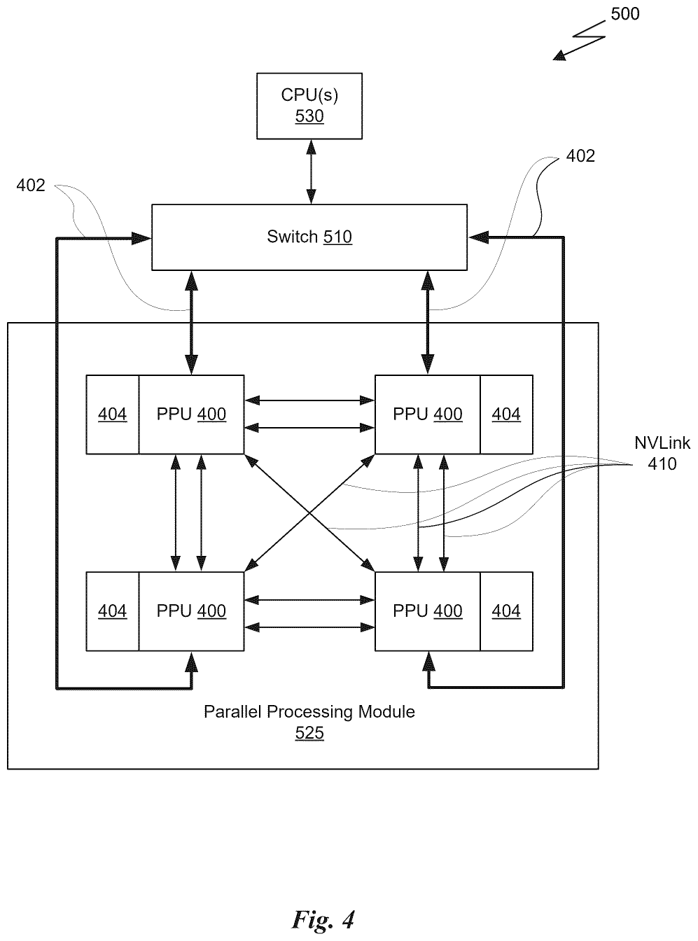

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404 or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Trec Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 252 connections are illustrated in FIG. 4, the number of connections to each PPU 400 and the CPU 530 may vary. The switch 510 interfaces between the interconnect 252 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 252 and each of the PPUs 400. The PPUs 400, memories 404, and interconnect 252 may be situated on a single semiconductor platform to form a parallel processing module 525. In yet another embodiment (not shown), the interconnect 252 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 252 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

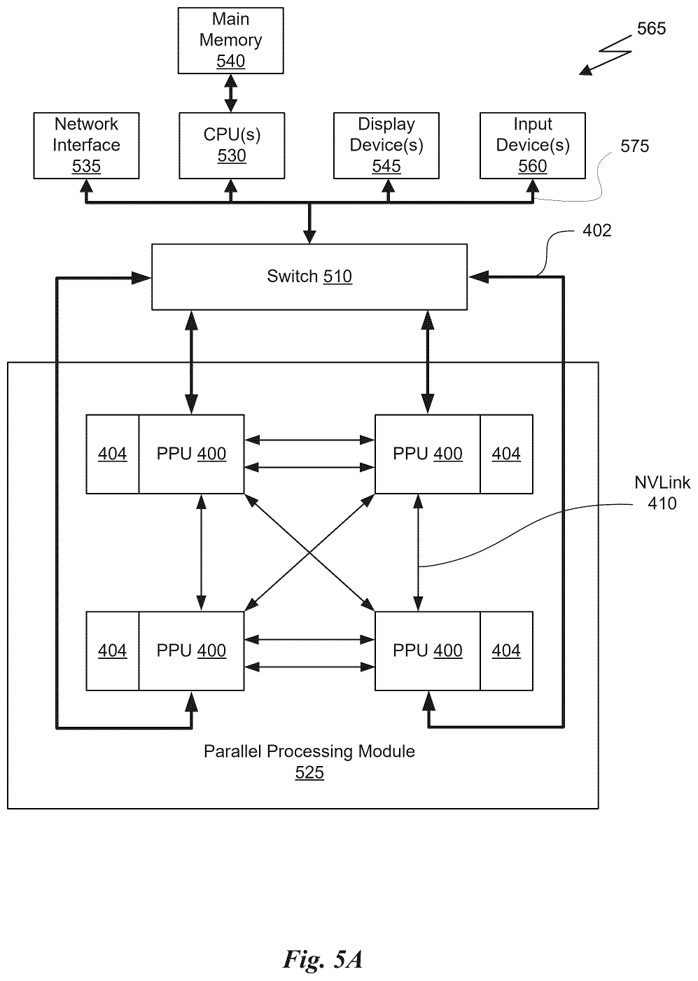

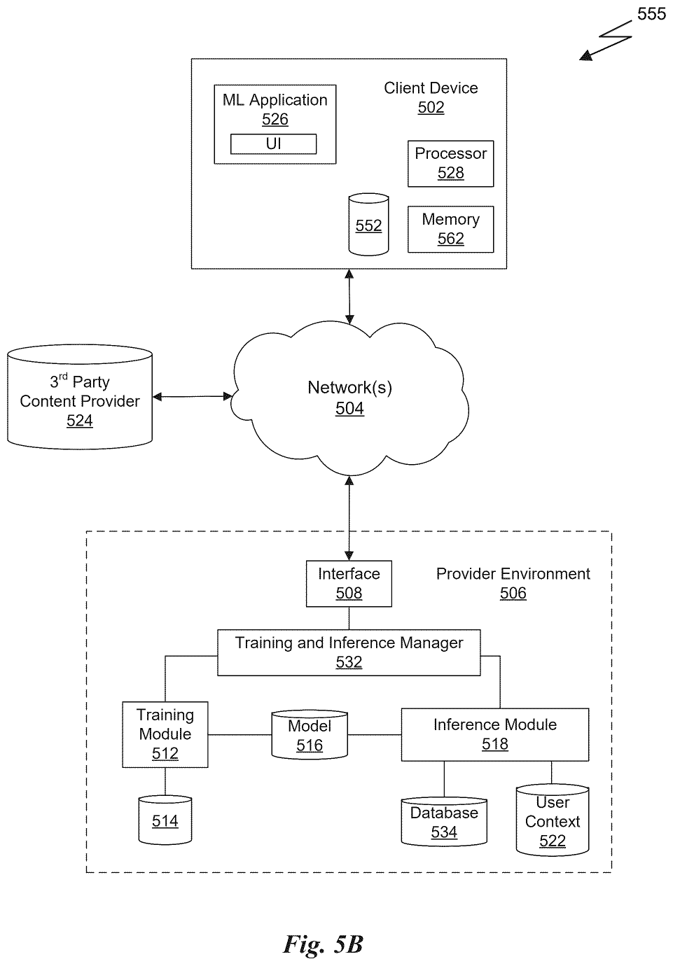

FIG. 5A illustrates an exemplary system 565 in which the various architecture and/or functionality of the various previous embodiments may be implemented. The exemplary system 565 may be configured to implement the method 300 shown in FIGS. 3A and 3B.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 302 or other such resource. In at least one embodiment, training data (or data to be analyzed by a trained neural network) can be provided by a provider, a user, or a third-party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third-party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used, or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third-party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

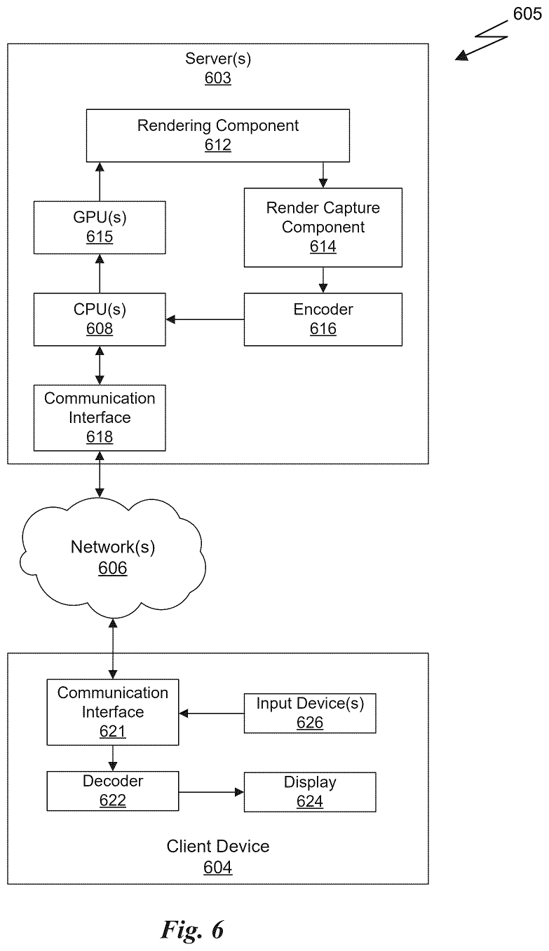

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic formats. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for automated generation of executable design rule checker (DRC) code, the method comprising:
receiving, by a first large-language model (LLM) agent, input prompting generation of executable DRC code for a design rule;
generating, by the first LLM agent and based on the input, a first text prompt requesting an explanation for the design rule as described in a foundry document;
generating, by a vision language model (VLM) module and based on the first text prompt and one or more visual representations of the design rule, textual output providing an explanation of the design rule described in the foundry document;
generating, by the first LLM agent and based on the textual output generated by the VLM module, a plurality of design rule conditions; and
generating, by a second LLM agent and based on the plurality of design rule conditions, the executable DRC code.

2. The method according to claim 1, wherein generating the textual output providing the explanation of the design rule comprises:
providing, by the first LLM agent and to the VLM module, the first text prompt to generate the explanation for the design rule, wherein the VLM module is a foundry rule analysis module; and
receiving, by the first LLM agent from the VLM module, the explanation for the design rule, wherein the explanation is generated by the VLM module based on analyzing a text description of the design rule in the foundry document and visual representations of the design rule in the foundry document.

3. The method according to claim 2, wherein generating the plurality of design rule conditions comprises:
generating, by the first LLM agent, a second text prompt requesting an interpretation for a design rule violation (DRV) in an example layout;
providing, by the first LLM agent and to a second VLM module, the second text prompt to generate the interpretation for the design rule violation, wherein the second VLM module is a layout DRV analysis module; and
receiving, by the first LLM agent and from the second VLM module, the interpretation of the design rule, wherein the interpretation is generated based on the example layout.

4. The method according to claim 3, wherein the first LLM agent combines the explanation of the design rule and the interpretation for the design rule violation to generate the plurality of design rule conditions.

5. The method according to claim 1, further comprising:
executing the executable DRC code on each of a plurality of example layouts to generate a corresponding plurality of outputs, each respective output corresponding to a respective example layout of the plurality of example layouts;
evaluating the executable DRC code by comparing each output of the plurality of outputs with a corresponding reference output; and
iteratively regenerating the executable DRC code based on the evaluation, wherein the evaluation comprises providing a performance report to the first LLM agent and the second LLM agent.

6. The method according to claim 5, wherein comparing each output of the plurality of outputs with the corresponding reference output comprises:
determining a score associated with the each respective output; and
initiating a new iteration of regeneration of the executable DRC code based on determining that the determined score is less than a threshold score.

7. The method according to claim 6, further comprising:
ending the iterative regeneration of the executable DRC code based on determining that the determined score is equal to the threshold score.

8. The method according to claim 6, wherein the new iteration of the regeneration of the design rule code further comprises:
generating the performance report based on the comparison of each respective output with the corresponding reference output;
generating a revised plurality of design rule conditions based on the performance report; and
generating a revised executable DRC code based on the revised plurality of design rule conditions and the performance report.

9. The method of claim 6, wherein further comprising:
determining a number of iterative regenerations of the executable DRC code previously performed; and
ending the iterative regeneration of the executable DRC code based on determining that the number of iterative regenerations previously performed is equal to or greater than a predetermined threshold.

10. The method of claim 6, wherein determining the score associated with each output comprises:
determining a set of true positives from each respective output based on comparing the respective output with the corresponding reference output;
determining a set of true negatives from each respective output based on comparing the respective output with the corresponding reference output;
determining a set of false positives from each respective output based on comparing the respective output with the corresponding reference output; and
determining a set of false negatives from each respective output based on comparing the respective output with the corresponding reference output.

11. The method of claim 10, wherein the score is determined based on a first score computed based on the set of true positives and the set of false positives, and on a second score computed based on the set of true positives and the set of false negatives.

12. The method of claim 1, wherein the input prompting generation of executable DRC code includes at least a text format and an image format.

13. A system for automated generation of design rule checking (DRC) code, the system comprising:
processing circuitry configured to:
receive, by a first large-language model (LLM) agent, input prompting generation of executable DRC code for a design rule;
generate, by the first LLM agent and based on the input, a first text prompt requesting an explanation for the design rule as described in a foundry document;
generate, by a vision language model (VLM) module and based on the first text prompt and one or more visual representations of the design rule, textual output generated by the VLM module, a plurality of design rule conditions; and
generate, by a second LLM agent and based on the plurality of design rule conditions, the executable DRC code.

14. The system according to claim 13, wherein the processing circuitry configured to generate the explanation of the design rule, is further configured to:
provide, by the first LLM agent and to the VLM module, the first text prompt to generate the explanation for the design rule, wherein the VLM module is a foundry rule analysis module; and
receive, by the first LLM agent from the VLM module, the explanation for the design rule, wherein the explanation is generated by the VLM module based on analyzing a text description of the design rule in the foundry document and visual representations of the design rule in the foundry document.

15. The system according to claim 14, wherein the processing circuitry is further configured to:
generate, by the first LLM agent, a second text prompt requesting an interpretation for a design rule violation (DRV) in an example layout;
provide, by the first LLM agent and to a second VLM module, the second text prompt to generate the interpretation for the design rule violation, wherein the second VLM module is a layout DRV analysis module; and
receive, by the first LLM agent and from the second VLM module, the interpretation of the design rule, wherein the interpretation is generated based on the example layout.

16. The system according to claim 15, wherein the first LLM agent combines the explanation of the design rule and the interpretation for the design rule violation to generate the plurality of design rule conditions.

17. The system according to claim 13, wherein the processing circuitry is further configured to:
execute the executable DRC code on each of a plurality of example layouts to generate a corresponding plurality of outputs, each respective output corresponding to a respective example layout of the plurality of example layouts;
evaluate the executable DRC code by comparing each output of the plurality of outputs with a corresponding reference output; and
iteratively regenerate the executable DRC code based on the evaluation, wherein the evaluation comprises providing a performance report to the first LLM agent and the second LLM agent.

18. The system according to claim 17, wherein the processing circuitry is further configured to:
determine a score associated with the each respective output; and
initiate a new iteration of regeneration of the executable DRC code based on determining that the determined score is less than a threshold score.

19. A non-transitory computer-readable medium having stored thereon instructions that, when executed by processing circuitry, cause the processing circuitry to perform a method for automated generation of design rule checking (DRC) code, the method comprising:
receiving, by a first large-language model (LLM) agent, input prompting generation of executable DRC code for a design rule;
generating, by the first LLM agent and based on the input, a first text prompt requesting an explanation for the design rule as described in a foundry document;
generating, by a vision language model (VLM) module and based on the first text prompt and one or more visual representations of the design rule, textual output providing an explanation of the design rule described in the foundry document;
generating, by the first LLM agent and based on the textual output generated by the VLM module, a plurality of design rule conditions; and
generating, by a second LLM agent and based on the plurality of design rule conditions, the executable DRC code.

20. The non-transitory computer-readable medium according to claim 19, wherein generating the textual output providing the explanation of the design rule comprises:
providing, by the first LLM agent and to the VLM module, the first text prompt to generate the explanation for the design rule, wherein the VLM module is a foundry rule analysis module; and
receiving, by the first LLM agent from the VLM module, the explanation for the design rule, wherein the explanation is generated by the VLM module based on analyzing a text description of the design rule in the foundry document and visual representations of the design rule in the foundry document, and
wherein generating the plurality of design rule conditions comprises:
generating, by the first LLM agent, a second text prompt requesting an interpretation for a design rule violation (DRV) in an example layout;
providing, by the first LLM agent and to a second VLM module, the second text prompt to generate the interpretation for the design rule violation, wherein the second VLM module is a layout DRV analysis module; and
receiving, by the first LLM agent and from the second VLM module, the interpretation of the design rule, wherein the interpretation is generated based on the example layout.
